(19) United States
(12) Patent Application Publication
(10) Pub. No.: US 2006/0086258 A1
(43) Pub. Date: Apr. 27, 2006

(54) Electronic cooking pan systems and methods

(76) Inventor: Richard Sharpe, Woodridge, IL (US)

Correspondence Address: LATHROP & GAGE LC, 4845 PEARL EAST CIRCLE, SUITE 300, BOULDER, CO, 80301, US

(21) Appl. No.: 11/302,587

(22) Filed: Dec. 14, 2005

Related U.S. Application Data
(63) Continuation of application No. 10/205,333, filed on Jul. 24, 2002.
Application No. 10/205,333 is a continuation-in-part of application No. 09/837,684, filed on Apr. 18, 2001, now Pat. No. 6,578,469.
(60) Provisional application No. 60/197,756, filed on Apr. 19, 2000.
(60) Provisional application No. 60/203,293, filed on May 11, 2000.
(60) Provisional application No. 60/212,169, filed on Jun. 16, 2000.
(60) Provisional application No. 60/260,038, filed on Jan. 5, 2001.

(51) Int. Cl. A47J 37/06

(52) U.S. Cl. 99/331

(57) ABSTRACT

A digital cooking pan provides temperature and/or food doneness information associated with food cooked within the pan. A thermal sensor coupled with the pan senses temperature and generates corresponding signals, and processing electronics coupled with the sensor convert the signals to data to provide indications to a user of food cooked within the pan. The cooking pan may be programmed to desired food types or personal temperatures or food doneness options. An electronic cooking system is also provided in which processing electronics generate a signal relating to cooking characteristics; the signal is transmitted to a cooking appliance controller connected to a cooking appliance to regulate energy output of one or more burners of the appliance. In this way, the heat generated by a cooking appliance for cooking in the digital cooking pan is automatically controlled while the pan is in use.

### RELATED APPLICATIONS

This application is a continuation of U.S. patent application Ser. No. 10/205,333, filed Jul. 24, 2002, which claimed priority to U.S. Provisional Application No. 60/197,756, filed Apr. 19, 2000, to U.S. Provisional Application No. 60/203,293, filed May 11, 2000, to U.S. Provisional Application No. 60/212,169, filed Jun. 16, 2000, and to U.S. Provisional No. 60/260,038, filed Jan. 5, 2001, and which was a continuation-in-part of U.S. Non-Provisional Ser. No. 09/837,684, filed Apr. 18, 2001, now U.S. Pat. No. 6,578,469, each of which is expressly incorporated herein by reference.

### BACKGROUND

Cooking over stove and fire has been an age-old occurrence. Assistance in cooking is desirable, such as to assure food temperature and doneness. Cooking pans are used in cooking—but provide no assistance in monitoring food temperature or doneness. One feature of the disclosed system is an electronic cooking pan that overcomes the deficiencies of the prior art. Other features will be apparent in the description that follows.

### SUMMARY

In one aspect, the system provides an electronic cooking pan with a thermally conductive pan for cooking food and a handle connected to the thermally conductive pan. The thermally conductive pan has one or more sensors attached therewith (e.g., inside or outside) to generate signals indicative of one or more characteristics (e.g., temperature) of the pan or food within the pan; the handle has electronics connected to the sensors for providing indications to a user of the cooking pan regarding food cooked within the pan. Preferably, the handle electronics may be removed from the handle, and later replaced, so as to wash the pan without exposing the handle electronics to washing environments. The handle electronics preferably have a display to show desired information, e.g., food temperature, to the user. Preferably, a processor is included with the handle electronics to process signals from the sensors to provide food characteristics, e.g., doneness. Sensitive electronics may be included within the handle electronics, and the handle electronics may be thermally shielded from frying temperatures in the pan so as to protect electronic components. User inputs to the processor (e.g., via the handle electronics) provide for selecting doneness (e.g., “well-done”) and food type (e.g., meat, poultry, eggs) options.

In one aspect, the system includes a digital frying pan, sensor electronics and a LCD display. The sensor electronics convert an analog sensor signal (for example, indicating pan temperature) into a digital signal for display at the LCD display of temperature in either Fahrenheit or Centigrade. A user of the digital cooking pan may read the display when facing the handle, and thus the display may be preferentially oriented for this view. The information displayed may change as pan or food temperature changes. In addition the display also may provide an analog representation of temperature, such as a bar graph. In one aspect, at least part of the sensor electronics is contained within a removable module, such that the module may be removed during washing of the digital cooking pan so as not to damage sensitive electronics. In another aspect, the LCD display is also incorporated into the removable module.

In yet another aspect, a remote food doneness system is provided. At least part of the system couples with a wall or other surface and has a line of sight to cooking food such as within a frying pan. The system includes optics and one or more thermal sensing detectors; the optics image a cooking food to the thermal sensing detectors; and processing electronics within the remote food doneness system process signals from the detectors to determine food characteristics, e.g., temperature. In one embodiment, a processor and memory within the remote food doneness system stores information such as food types (e.g., eggs, chicken, beef) and corresponding food doneness and temperature settings. A user interface permits a user of the system to select food doneness options. The system may include an audible or visual indicator to warn of programmed events, e.g., when food viewed by the system has reached desired temperatures or doneness. The system in one aspect, for example, may thus “view” cooking eggs and warn a user desiring the eggs that the eggs are “over easy”.

In one aspect, an electronic cooking pan system is provided. The system includes a pan for cooking food and a handle connected to the pan for manipulating the pan. One or more temperature sensors connect with the pan to generate signals indicative of one or more characteristics of the pan, such as temperature. Indication electronics disposed with the handle connect with the sensors to provide at least one indication of the characteristics to a user of the pan.

In one aspect, the indication electronics include a liquid crystal display to display the one or more characteristics to the user. By way of example, pan temperature is relayed to the user. Pan temperature may be calibrated to food temperature, as the food is generally not directly adjacent to a temperature sensor.

In one aspect, the indication electronics include a processor to process the signals to associate food characteristics to food cooking within the pan. Food characteristics can include food doneness, temperature, cooking duration and/or other factors.

In another aspect, a user interface is included with the cooking pan to provide for selecting one of several food types, such that the processor generates food characteristics as a function of food type. Similarly, food temperatures may be selected in another aspect. Still further, each of the food types may be adjustably set to correspond to a selected cooking temperature varying from a preselected temperature (e.g., steaks cook at 430 degrees F., instead of preset temperature of 410 degrees F.).

In one aspect, the indication electronics are detachable and alternatively attachable with the handle, such that the pan may be washed without the indication electronics.

In another aspect, the indication electronics have voice synthesis electronics to speak at least the one food characteristic to the user.

The indication electronics may include a memory element for storing food doneness versus temperature settings for one or more food types.

In another aspect, an audible alarm is coupled with the indication electronics to audibly inform a user of the pan system about food characteristics of food within the pan.

In one aspect, the indication electronics include a calibration memory to allow the coupling of the indication electronics with a plurality of different size pans, such that the indication electronics provide calibrated information for the different size pans.

In another aspect, a method of cooking food in a frying pan is provided and includes the steps of: sensing temperature of the frying pan, processing pan temperature to determine one or more of food doneness and/or a food temperature, and informing a user of the pan of the food doneness and/or food temperature.

The method may also include the steps of decoupling processing electronics from the cooking pan prior to washing the pan and alternatively coupling the processing electronics with the cooking pan prior to use.

The method may include the steps of decoupling processing electronics from the cooking pan and coupling the processing electronics with a second pan having a different size from the cooking pan, and selecting calibration data with the processing electronics to provide calibrated information for the different size second pan.

In another aspect, a method is provided for remotely monitoring temperature of food, including the steps of: imaging the food onto a thermal sensor, processing signals from the thermal sensor to determine the temperature, and informing the user of the temperature.

The method of this aspect may include the step of attaching a housing coupled with the sensor to a surface in line of sight from the food.

In yet another aspect, the method includes the further step of imaging the food onto a CCD to display an image of the food to the user. A user may thus physically arrange appropriate mounting of the housing so as to ensure proper thermal sensing.

The system of one aspect calibrates a thermal sensor arranged to sense temperature at the side of the pan. Since the side of the pan generally has a different temperature than the center of the pan, where food cooks, the system calibrates the temperature taken at the side of the pan to correlate to the center of the pan. Software with the electronics module provides smoothing of the data based on rate of change of temperature at the side of the pan. This provides an average rate of change usable to compensate for temperatures in the pan center.

In still another aspect, a wireless electronic cooking system is provided in which a pan and associated electronics interface with a cooking appliance controller to control the energy output of the burners of the appliance. The system includes an input interface on the pan in which the user selects the desired cooking characteristics (e.g., food temperature, food doneness, etc.); a transmitter communicates a signal relating to the food characteristic to a receiver connected with the cooking appliance controller; the controller regulates the energy produced by the burners based on the received signal. This allows automatic control burner output without manual adjustment on the appliance. A burner may include a gas burner or an electrical hot plate.

In another aspect, an extendable sensor probe is provided. The probe is mounted on the pan handle and connected with the indication electronics. The sensor probe has a probe body housing a temperature sensor and a probe wire to send signals to the indication electronics. This allows the probe body to be moved to a location in which it may be inserted into a food item being cooked to measure the temperature thereof. An elongated slot is preferably provided in the pan handle to cradle the probe body therein for storage.

In another aspect, a method is provided for cooking food in a pan, including the steps of: selecting one or more desired cooking characteristics on an input interface on the pan, transmitting a signal to a cooking appliance relating to the selected cooking characteristics, sensing temperature of the pan, processing pan temperature to determine food doneness and/or food characteristics, and informing a user of the pan of the food doneness and/or food characteristics.

### BRIEF DESCRIPTION OF THE DRAWINGS

FIG. 1 shows one electronic cooking pan system;

FIG. 2 shows a partial cross-sectional view of the handle and pan system of FIG. 1;

FIG. 3 shows one block diagram of circuitry suitable for use with an electronic pan system of FIG. 2;

FIG. 4 shows one electronics handle; FIG. 4A shows an end view of the handle of FIG. 4; FIG. 4B shows a cross-sectional side view of the handle of FIG. 4;

FIG. 5 shows one remote food doneness system;

FIG. 6 schematically shows an electronic block diagram of the system of FIG. 5;

FIG. 7 shows one electronic cooking system;

FIG. 8 shows one sensor probe and handle of one pan;

FIG. 9 shows a cross-sectional view of one pan body; and

FIG. 10 shows one block diagram of circuitry suitable for use with an electronic pan of FIG. 9.

### DETAILED DESCRIPTION OF THE DRAWINGS

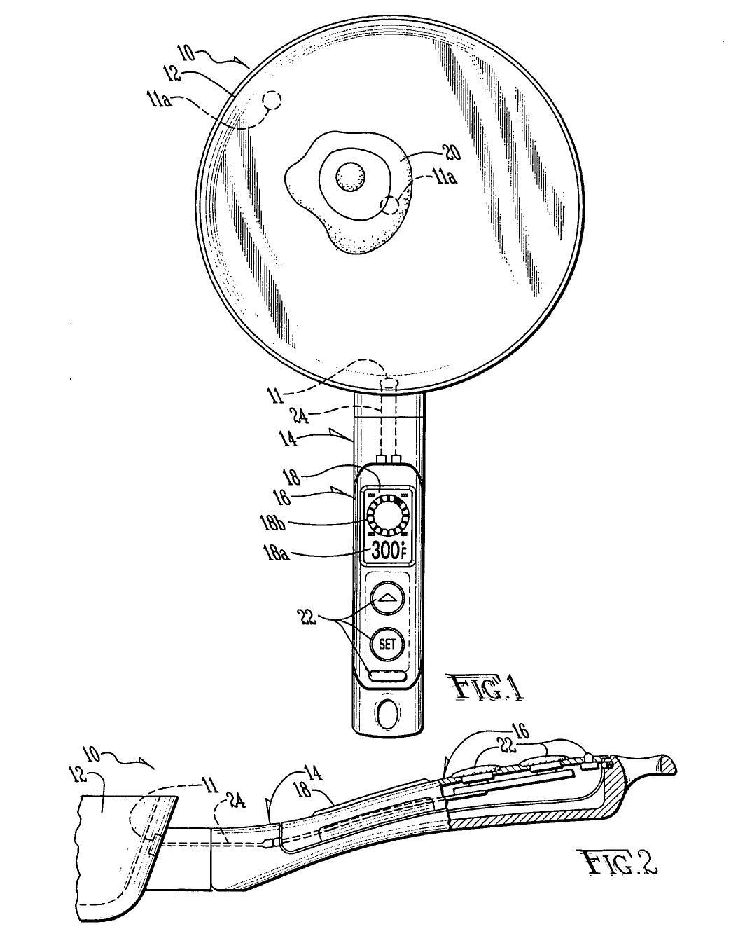

FIG. 1 shows an electronic cooking pan system 10 with (a) a thermally conductive pan 12 and (b) a handle 14. One or more temperature sensors 11 coupled with pan 12 connect to an electronics or control module 16 in handle 14. Electronics module 16 may include display 18 to show a user of pan system 10 characteristics associated with pan 12 or food (e.g., in the form of an egg) 20 within pan 12. Electronics module 16 includes a processor such as a microprocessor and may include memory to store food doneness options, user selections and/or other information. A user interface 22 provides for user input to select various characteristics and functions of electronics module 16. Display 18 may show digital temperature 18a, a bar graph representation 18b of temperature or doneness, or other information. As described below, electronics module 16 may detach from pan system 10 so that pan 12 is washable without module 16 attached thereto. Teflon wires may seal the remaining portions of handle 14 to prevent liquids from entering electronics remaining after removal of module 16.

Temperature sensors 11 may include, for example, a thermistor or thermocouple. Thermocouple 11 couples to electronics module 16 via electronic or thermal conductive path 24; path 24 is chosen as a matter of design choice as a medium to transfer data or signals from sensor 11 to module 16. Stainless steel may be used to provide contact between module 16, path 24 and sensors 11. FIG. 1 shows one temperature thermocouple 11 coupled with conductive pan 12, though additional sensors 11 may be placed about pan 12 as a matter of design choice. For example, one or more additional temperature sensors may be placed at different locations 11a; sensors at locations 11a also connect to module 16 and may provide additional representative temperature data for food 20. A temperature sensor 11 may be calibrated to correspond to a temperature profile experienced by food 20, even though sensor 11 is not directly adjacent food 20. For example, knowing pan materials, size and geometry, thermal transfer algorithms may be used to extrapolate pan surface temperatures at the pan center even though sensor 11 may be located near the edge of pan 12, as shown in FIG. 1. Typical pan calibrations are for pans that are eight, ten or twelve inches in diameter. Calibration may also be done by selecting the calibration mode on user interface 22 and boiling water in pan 10. By reading the measured pan temperature and knowing the boiling temperature of water at the location of use (e.g., taking altitude and other factors into account), a value may be assigned to the difference and input to user interface 22 for calibrating the measured temperature.

FIG. 7 depicts an electronic cooking system 200. System 200 may include an electronic cooking pan 201 that has certain operations and functions like pan system 10 of FIG. 1 (like numbers indicating like functions). The thermally conductive pan portion 12′ receives food to be cooked. A transmitter 17 may connect to, or integrate with, control module 16′ on the handle 14′. The transmitter 17 may communicate wirelessly with a receiver 202 connected to a cooking appliance controller 204 that controls energy output of one or more burners (1, 2, 3, 4) of a cooking appliance 208. Based on user input to user interface 22′ of control module 16′, certain signals may be transmitted to cooking appliance controller 204. These signals may include a target temperature, a current temperature and a specific burner position where cooking pan 201 is located (e.g., burner number 2), the target temperature and burner position being chosen by the user on user interface 22′. Such signals may be sent at least about every 10 seconds such that controller 204 may quickly regulate energy output based on the condition of food 20′ being cooked. When receiver 202 transfers the signals to controller 204, controller 204 may increase, maintain, decrease or shut-off the energy output of the associated burner (1, 2, 3, 4) to properly cook food item 20′ based on the user's input. If sensors 11′sense a pan temperature that exceeds a set temperature, e.g., 450 degrees F., a signal may be transmitted to controller 204 to shut off the appropriate burner (1, 2, 3, 4), to avoid damage or other undesired effect. Receiver 202 and controller 204 may mount on a cooktop surface 210 of cooking appliance 208, under surface 210, or at some other location that allows for control of burner energy output. Receiver 202 and controller 204 may also be combined as an integral electronics module.

In one embodiment, a user of pan system 10 (or cooking system 200) may select pre-programmed temperature settings or program personal settings to cook food 20, 20′ in a desired manner. For example, the user of interface 22, 22′ may allow for selection of specific temperatures, or of food types and doneness levels that are associated with pre-programmed settings (e.g., 200 degrees F. for “melting” a food item, 280 degrees F. for eggs, 300 degrees F. for bacon, 350 degrees F. for pancakes, 380 degrees F. for burgers and pork chops, and 400-420 degrees F. for steak). The programmed personal settings may facilitate choosing of a selected cooking temperature varying from a preselected temperature (e.g., change food type menu such that steaks cook at 380 degrees F., instead of preset temperature of 400-420 degrees F.). A cooking temperature may also be selected manually, whether for a single cooking session or as a desired temperature until changed in the future. Other options may be available without departing from the scope of the present disclosure. In one embodiment, displays 18, 18′ may display the temperature of pan 12, 12′, respectively, in Centigrade or Fahrenheit. Thus, various cooking levels may be selected on user interface 22, 22′. When a cooking level is selected, microprocessors in modules 16,16′ may provide signals converted to display 18, 18′, respectively, that inform the user that the temperature is at his desired chosen cooking level. In one example, when the user has completed the selection of the desired temperature settings or cooking program on user interface 22′, control module 16′may assess the information received from sensors 11′ and generate a signal to be communicated to cooking appliance controller 204 via transmitter 17 and receiver 202.

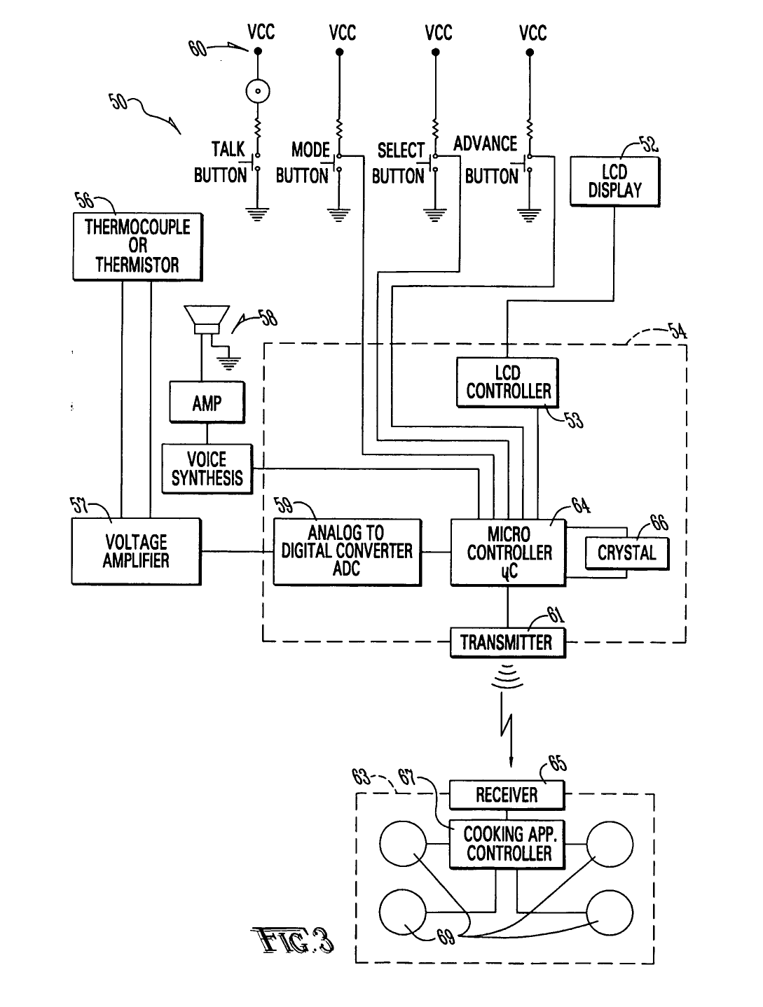

FIG. 2 shows a partial cross-sectional view of pan 10 of FIG. 1. Those skilled in the art should appreciate that the mechanical design of pan 10 is a matter of design choice and that other configurations may be functionally arranged without departing from the scope of the present disclosure.

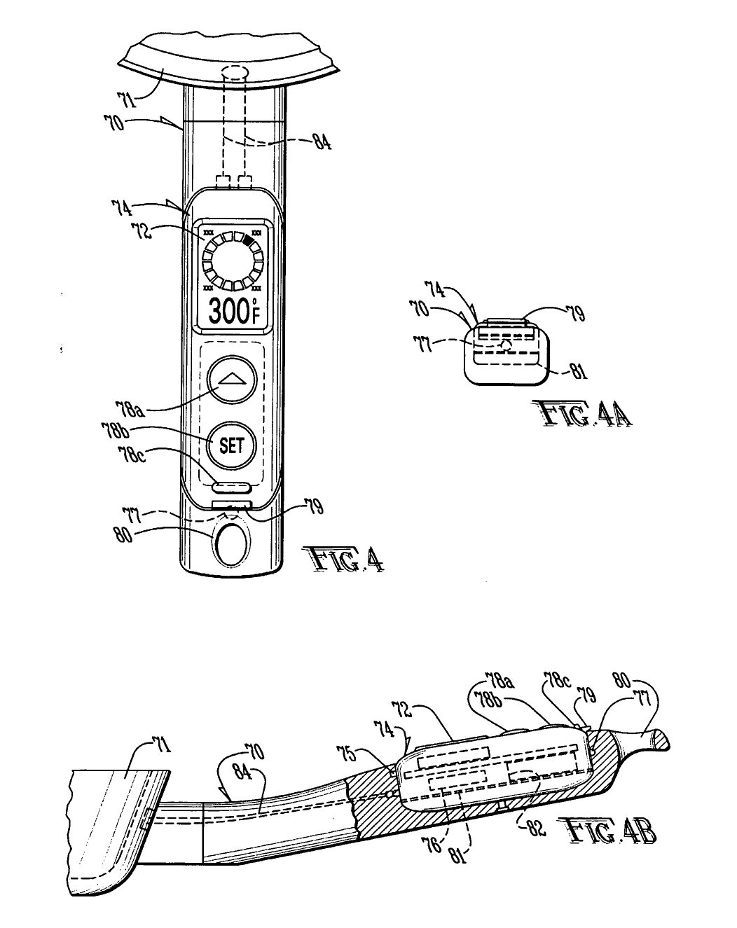

FIG. 3 schematically illustrates circuitry 50 suitable for use with cooking pan system 10 of FIG. 1 and/or system 200 of FIG. 7. A LCD display 52 may for example be used as display 18; an LCD controller 53 may generally control display 52. Dotted line 54 indicates one practical partitioning of components of circuitry 50 that may be conveniently contained within one package. A thermocouple or thermistor 56 may serve in function as one of the sensors 11, 11′ to generate signals concerning characteristics of the pan and/or food within the pan. A voltage amplifier 57 may be used to boost sensor signals, as desired or needed. An A-D converter 59 may generally be used when sensor 56 drives an analog signal. In one embodiment, the handle electronics module may include voice synthesis electronics 58 used to capture human voice commands for pan or food characteristics made by a user of pan system 10, 200. Users may input instructions to circuitry 50 via input buttons 60 (e.g., for user interface buttons 22 of FIG. 1, 22′ of FIG. 7) so as to select desired food or doneness characteristic, for example. A microcontroller 64 may provide for overall function and command intelligence of circuitry 50; for example microcontroller 64 may adjust cooking time based on surface temperature of pan 12 of FIG. 1 or pan 12′ of FIG. 7. A crystal 66 may provide for timing in circuitry 50. A transmitter 61 may communicate signals relating to user input instructions as processed by microcontroller 64 to a receiver 65 of a cooking appliance 63 (e.g., appliance 208). Receiver 65 may connect with a cooking appliance controller 67 that regulates energy output of one or more burners 69 of appliance 63 based on the signals.

FIGS. 4, 4A, 4B show one handle 70 suitable for use with an electronic cooking pan 71 (shown only partially, for purposes of illustration) such as pan 12, FIG. 1. A display 72 shows food or pan characteristics. The handle electronics may take on the form of a removable control module 74, as shown; a module alignment nub 75, ball snap 77, and lip 79 may be used to facilitate removing from, and alternatively replacing module 74 within, handle 70. A battery 76, e.g., a 2450 Lithium battery, may fit with handle 74; battery 76 may be removed from module 74 via access door 81. User interface buttons 78a, 78b, 78c may provide for “advance”, “set”, and “mode” menu options, respectively. Exemplary mode options include the use of pre-programmed temperature settings for food types, personal temperature settings, food doneness settings, burner number in use, pan calibration, and a timer for timing the duration of cooking at a selected temperature or for a selected cooking session. The “advance” button may be used to select from a list of food types, a list of doneness levels, a range of cooking times, calibration adjustment values and/or to adjust to a selected cooking temperature varying from the pre-programmed settings. A hang hole 80 may assist hanging of handle 70 on a hook. A warning buzzer 82 may provide an audible warning of programmed food doneness and/or a food character sensed by temperature sensors coupled with module 74 via communications lines 84.

The system disclosed herein thus provides several advantages. By way of example, eggs are one food difficult to cook with certainty as to whether they are well done, over easy or medium. The system may provide for retrieving a pre-programmed temperature for desired egg doneness, such that a user need not rely on stove temperature settings. A microcontroller may automatically signal the user (e.g., via buzzer 82, FIG. 4B) when the desired egg doneness is reached. Since the display can include an analog representation of doneness, e.g., via a bar graph or tachagraphic display, then the user may also watch food approach the desired doneness, so as not to be surprised. User selections at the user interface (e.g., by pressing button 22, FIG. 1) may provide for selecting doneness options (e.g., over easy) and food types (e.g., eggs); or a user may select custom temperatures. In a further advantage, the replaceable module (e.g., module 16, FIG. 1) may be used in an array of pans of different size—but with a common electronics module. When the module is coupled with a certain pan size, the user may set pan size through the user interface so as to adjust calibrations to temperature sensors with the particular pan.

In one method of operating a pan system 200 described herein, the user may make desired selections on the user interface 22′ (e.g., cook steak on burner 2). The control module 16′ may determine what cooking temperature corresponds to the food type or program chosen, and may further determine whether a food doneness level is selected (e.g., cook steak until medium-rare). Based on the input, control module 16′ may review signals received from sensors 11′ and generate the appropriate signal to be transmitted by transmitter 17 to receiver 202 connected to cooking appliance controller 204. For example, the signal may indicate that the current pan temperature is 80 degrees F., the target pan temperature is 380 degrees F., and the burner in use is number 2. Upon receiving the signal, controller 204 may increase the energy output of burners (1, 2, 3, 4) until the target temperature is reached and thereafter maintain such temperature until further input is received from control module 16′. If the user selects a cooking time on user interface 22′, or if such time is stored automatically in a menu in control module 16′, at the elapse of such time a signal may be sent to controller 204 to shut-off the appropriate burner.

The electronic cooking system 200 thus aids in avoiding overcooking of food items in pan 12′by automatic adjustment of burner energy output by cooking appliance 208. If the pan temperature exceeds a specific number as sensed by sensors 11′, e.g. about 450 degrees F., module 16 may generate a signal to instruct controller 204 to shut off the appropriate burner (e.g., 1, 2, 3 or 4). This may reduce the chances of creating cooking fires, especially if the user leaves the pan 10 unattended for a period of time.

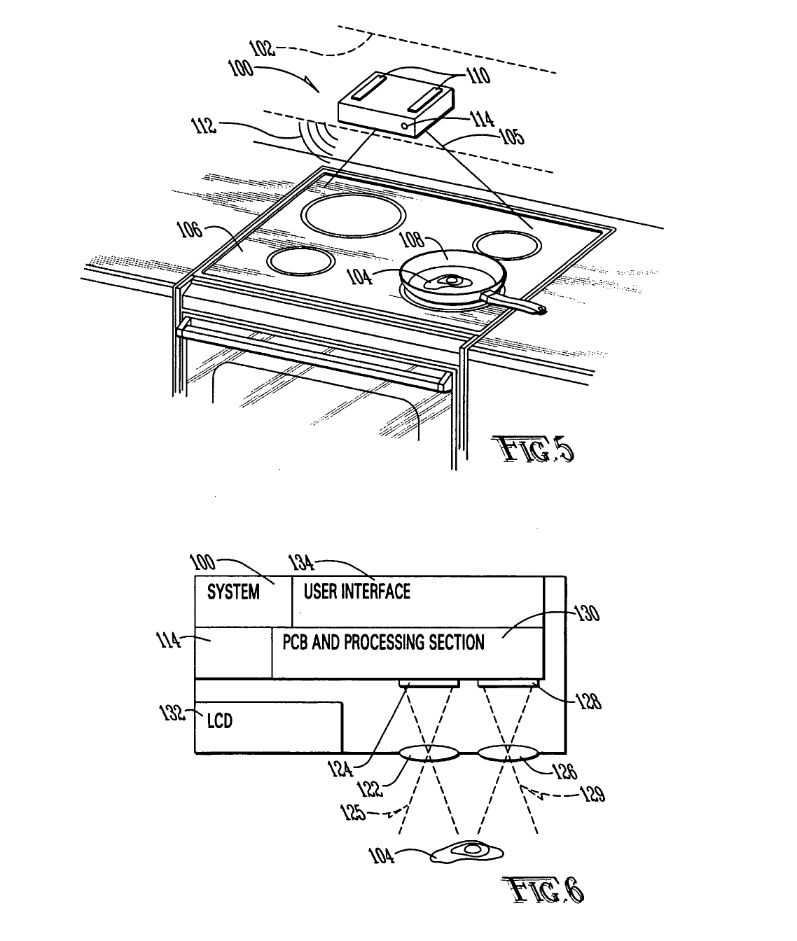

FIG. 5 shows one remote food doneness system 100. System 100 is constructed and arranged to attach to surfaces 102 near to cooking food 104, such as food on stove 106 and within cooking pan 108. By way of example, system 100 attaches to surface 102 via magnets 110 coupled with system 100; surfaces 102 are typically metallic surfaces that are part of stove 106. In operation, system 100 views food 104 through a field of view 105; system 100 then monitors food doneness and/or temperature of food 104 to provide an indication 112 of doneness and/or food characteristics to a user. Typically, indication 112 may be an audible sound or light made, respectively, from a speaker or LED 114. System 100 thus provides operation similar to the pan system of FIGS. 1-4; however system 100 functions remotely from food 104.

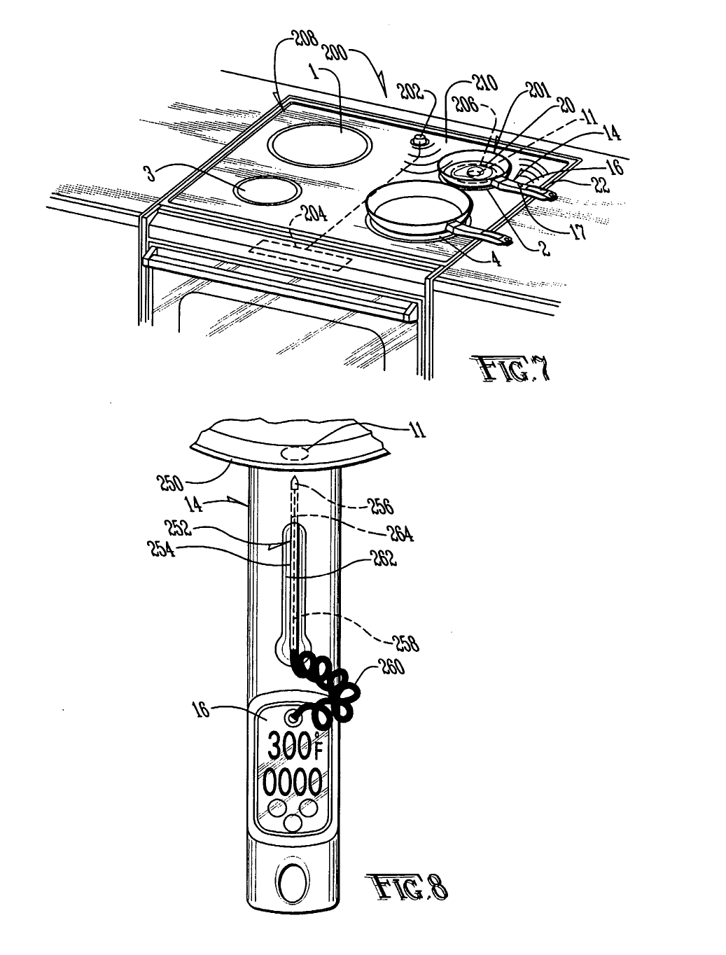

FIG. 6 shows a block schematic of system 100; those skilled in the art should appreciate that elements of system 100, as shown in FIG. 6, may be arranged in different ways, or through different components, without departing from the scope of the present disclosure. An infrared optically powered element (e.g., a mirror or Germanium lens) 122 images food 104 onto an array of thermal detectors 124 (e.g., bolometers), as shown by optical imaging lines 125. A visible optically powered element (e.g., a quartz lens) 126 images food 104 onto a CCD array 128, as shown by optical imaging lines 129. A printed circuit board (PCB) and processing section 130 converts signals from CCD array 128 to data for LCD 130; PCB and processing section 130 converts signals from thermal detectors 124 to temperature data indicating a temperature of food 104; a user may view LCD 132 to view what food 104 system 100 monitors; specifically, by reviewing LCD 132 a user may position system 100 appropriately on surface 102 so as to appropriately image food 104 to thermal detectors 124. A user interface 134 provides for inputting selections for temperature and food doneness to system 100; preferably PCB and processing section 130 includes memory to store food doneness options and food types, similar to pan systems described herein. Once a selected food characteristic or food doneness is reached, for food 104, system 100 informs the user of this through indicator 114 (e.g., a buzzer or LED). In this way, a user of system 100 can monitor food doneness and temperature for a food remotely and conveniently. As those skilled in the art understand, determining temperature of food 104 via thermal detectors works best when a reference temperature is available; thus thermal detectors 124 may include one detector to receive thermal energy from a reference temperature such as the inside of system 100, which is generally at room temperature (e.g., 300 K). Data from detectors 124 may then be compared (in PCB and processing section 130) to determine temperature of food 104. Other calibration techniques for determining absolute temperature may also be used.

Those skilled in the art should appreciate that system 100 may utilize a single infrared CCD to provide both imaging for LCD display 130 and temperature monitoring of food 104. In such an embodiment, separate lens 126 and CCD array 128 are not necessary.

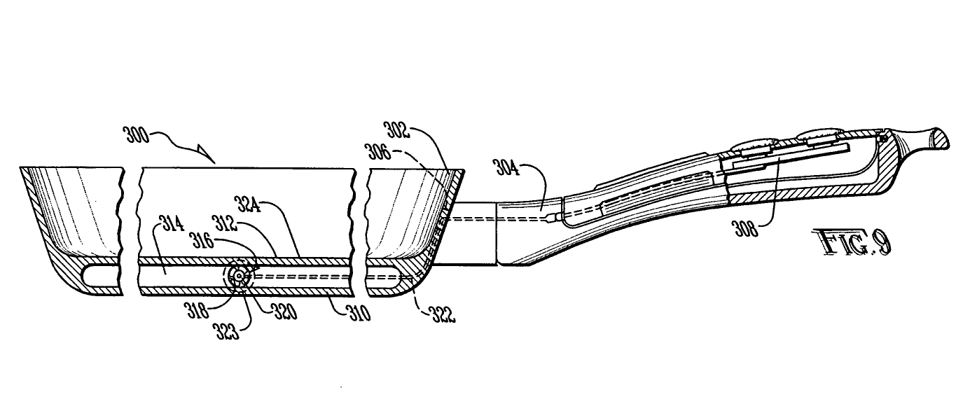

FIG. 8 depicts an electronic cooking pan system 250 and further includes a sensor probe 252 connected with control module 16″ of pan 250. Probe 252 has an elongated probe body 254 housing one or more temperature sensors 256, such as thermistors or thermocouples, connected via electronic or thermal conductive path 258 to a probe wire 260. Probe body 254 may include a thermally insulative section that may be grasped for insertion into a food item. Probe wire 260 may be an insulated, coiled wire interconnecting probe body 254 with control module 16″ such that signals generated by sensors 11″ are received by module 16″ for processing, to display food characteristics such as temperature. Probe wire 260 may have a length of at least 10 inches uncoiled such that probe body 254 may extend away from control module 16″ and pan handle 14″ to the location of food being cooked in pan 250. To allow for storage of probe body 254, an elongated slot 262 may be formed in handle 14″ and sized and configured to securely hold body 254. Slot 262 may, for example, have upper lip sections 264 to restrict movement of probe body 254 to a single insertion and removal direction to more securely store body 254. Alternatively, a clip (not shown) may attach to handle 14″ and be configured to bias the probe body 254 therein. The temperature readings of probe 252 may be displayed on control module 16″, and may be used by module 16″ in generating signals transmitted to cooking appliance controller 204 for controlling burner energy output for cooking. Knowing the difference between the pan temperature sensed by sensor 11″ and the food temperature sensed by probe 252, cooking appliance controller 204 may further adjust burner output to regulate heat transfer through the food to cook the food at the proper rate as to maintain flavor and achieve the desired doneness.

In one embodiment, sensor probe 252 may substitute for sensors 11 and conductive path 24 of the electronic cooking pan system 10 of FIG. 1. Thus, temperature signals received by control module 16 relate to food in which the probe body 254 is placed, or to a section of pan 250 with which the probe body 254 is in thermal contact, as opposed to also including the pan temperature readings at the location of sensor 11.

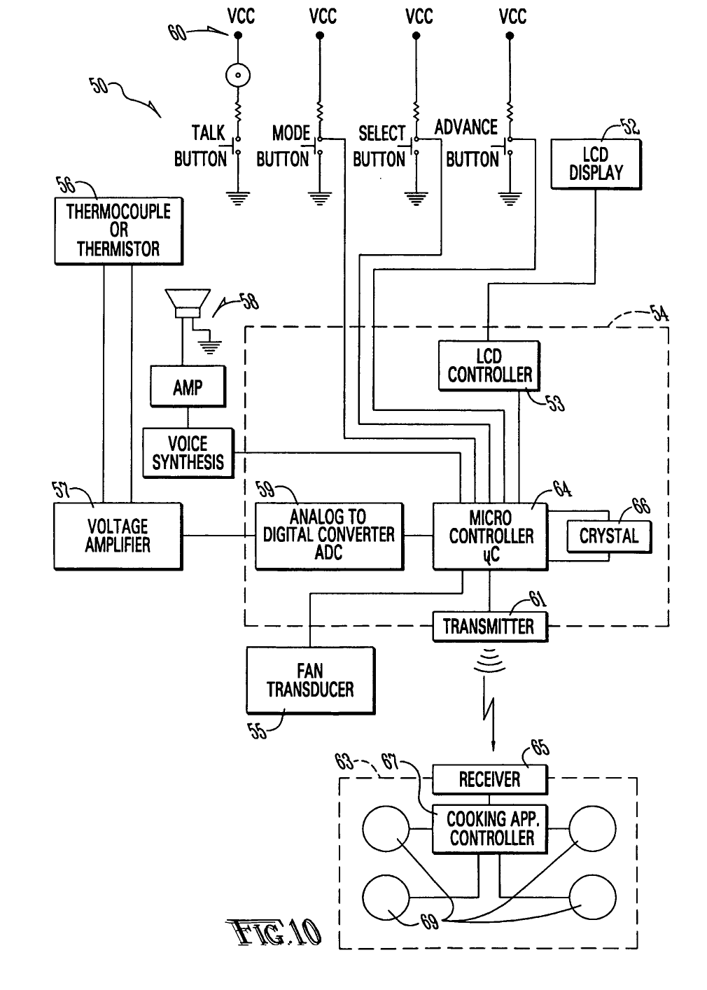

FIG. 9 depicts another electronic cooking pan 300. Pan 300 has body 302 section and a handle 304, and temperature sensor 306 couples with pan body 302 and connects to electronics module 308 in handle 304. Body section 302 has a lower region 310, a cooking surface 312 and a cavity 314 formed therebetween. An air inlet/outlet 316 is provided on a sidewall 318 of the body and extends into cavity 314. More than one inlet/outlet 316 may be provided based on designed air flow through cavity 314. A fan transducer 320 may mount adjacent to air inlet/outlet 316 to force air into and out of cavity 314. Fan transducer 320 receives electrical energy through a conductive path 322 that extends to electronics module 308 for regulation of power input to fan 320. By drawing ambient air into cavity 314, cooking surface 312 may be convectively cooled after a cooking cycle has been completed with the pan 300, or upon sensors 306 registering a temperature reading that is above the maximum allowable for the pan body 302 (e.g., 450 degrees F.). This further speeds up the cooling process of pan surface 312 so that pan 300 can be handled or cleaned quickly after use without the risk of the user being burned by contacting surface 312. An optional sealing baffle 323 may be placed over air inlet/outlet 316 and fan 320 when fan-induced convective cooling is not desired, or when pan 300 is being cleaned such that water will not harm fan circuitry. Fan transducer 320 and inlet/outlet 316 may be positioned at other or additional locations with pan body 302, so long as they remain in fluid communication with cavity 314, to control the temperature of surface 312. By way of example, inlet/outlet 316 and transducer 320 may reside near to handle 304 so as to reduce heat exposure at pan bottom 310, thereby protecting electronics.

The cooking surface 312 of the electronic cooking pan 300 of FIG. 9 is shown to have a flat, planar configuration that may be generally described as a “paddle”shape. This cooking surface configuration may also be utilized to form the thermally conductive pan 12 of FIG. 1, and a thermally conductive cooking portion 12′ of electronic cooking pan 201 of FIG. 7. In this way, cooking surface 312 forms a flat pan interface 324, allowing other cooking items, such as pots and pans, to be placed thereon. By use of the electronic module 308 of the pan 300, the amount of heat traveling through the cooking surface 312 to the pot or pan for cooking food therein may be regulated. Thus, the benefits of automatic temperature control of pan temperature (e.g., through burner feedback or air-cavity flow) may be provided to pots and pans varying in size, so long as such pots and pan are sized to rest upon surface 312.

FIG. 10 schematically illustrates circuitry 50′ suitable for use with cooking pan system 10 of FIG. 1 and/or system 200 of FIG. 7. Circuitry 50′ is similar to circuitry 50 of FIG. 3 but adds a conductive path from microcontroller 64′ to the fan transducer 55′ to control electrical energy discharge to transducer 55′. For example, when sensor 56′ registers an excessive temperature, or when the user chooses to cease operation of a cooking session, microcontroller 64′ allows energy discharge to fan transducer 55′ for fan operation to cool cooking surface 312 of FIG. 9. If other cooking items (i.e., pots and pans) are placed upon surface 312, they too will experience accelerated cooling by fan operation since heat will be conducted from the cooking item to the surface 312 that is cooling. Upon the passage of a certain amount of time, user input, or sensor 56′ registering an acceptably low temperature, microcontroller 64′ may cut off energy discharge to transducer 55′ and the fan will cease operation.

The changes described above, and others, may be made in the systems and methods described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A cooking system, comprising:
a cooking burner;
a sensor for sensing one or more of food temperature and food doneness of food cooking within a pan on the burner;
a transmitter for transmitting wireless signals indicative of the food temperature and food doneness;
a controller for receiving the wireless signals and for automatically regulating energy output by the cooking burner based upon the food temperature and food doneness.

2. A temperature regulating cooking system, comprising:
a pan for cooking food when heated underneath by a stove burner;
a temperature sensor for sensing temperature of the food, and for generating signals of the temperature; and
a temperature controller responsive to the signals to automatically control pan temperature.

3. A system of claim 2, the pan forming a frying pan with a pan wall for containing the food.

4. A system of claim 2, the pan forming a substantially flat upper surface to support a second pan.

5. A system of claim 4, the second pan comprising a pot.

6. A system of claim 4, the temperature sensor comprising one of a thermocouple and thermistor coupled with the pan, to sense pan temperature.

7. A system of claim 2, the pan forming a cavity between the burner and an upper surface of the pan, and further comprising a fan transducer in fluid communication with the cavity, the temperature controller driving the fan transducer to adjust air flow within the cavity to modify the pan temperature.

8. A system of claim 2, the temperature sensor comprising a remote thermal imaging unit for imaging infrared energy of the food.

9. A system of claim 2, the pan having a handle for manipulating the pan, further comprising handle electronics disposed with the handle, coupled with the temperature sensor and including a processor for generating the signals as wireless information, the temperature controller comprising a stove controller for receiving the wireless information and for automatically adjusting energy output by the stove burner based on the temperature.

10. A system of claim 2, the temperature sensor including a processor for generating the signals as wireless information, the temperature controller comprising a stove controller for receiving the wireless information and for automatically adjusting energy output by the stove burner based on the temperature.

11. A system of claim 2, further comprising an LCD display for displaying one or both of food doneness and food temperature.

12. An electric cooking pan having one or more temperature sensors and indication electronics connected with the sensors for indicating one or more of food temperature and food doneness to a user of the pan.

13. The system of claim 12, further comprising an input interface for selecting food temperature and food doneness.

14. The system of claim 12, wherein the indication electronics display a measured temperature and a selected temperature.

15. The system of claim 12, wherein the indication electronics comprise a liquid crystal display for displaying at least one indication to the user.

16. The system of claim 12, wherein the indication electronics form part of a control module.

17. The system of claim 16, wherein the control module is detachable and alternately attachable with a handle, wherein the pan may be washed without the control module.

18. The system of claim 16, wherein the control module comprises memory for storing food doneness versus temperature settings for one or more food types.

19. The system of claim 16, wherein the control module further comprises a processor for processing temperature sensor signals, the input interface being connected with the processor.

20. The system of claim 16, wherein the control module further comprises calibration memory, the calibration memory configured for coupling the control module with a plurality of different size pans, wherein the control module provides calibrated information for the different size pans.
